(19) United States
(12) Patent Application Publication
(10) Pub. No.: US 2025/0328388 A1
(43) Pub. Date: Oct. 23, 2025

(54) DATA CONNECTION OBJECT WITH DYNAMIC GOVERNANCE ATTRIBUTES AND ENFORCEMENT

(71) Applicant: Dell Products L.P., Round Rock, TX (US)

(72) Inventors: Michael James Pittaro, La Honda, CA (US); Todd Sumner Littlefield, Goffstown, NH (US)

(21) Appl. No.: 18/640,598

(22) Filed: Apr. 19, 2024

(51) Int. Cl. G06F 9/50

(52) U.S. Cl. CPC G06F 9/5027

(57) ABSTRACT

One or more embodiments relates to a method for establishing a connection. The method includes initiating, by a data connection object, a first attempt to establish a first connection between an application and a first host in a data system, obtaining, from a governance system, governance requirements for the first connection, making a first determination that the first connection meets the governance requirements, establishing, in response to the first determination, the first connection between the application and the first host, and generating, after the establishing, a first new entry on a data connection catalog associated with the first connection.

### BACKGROUND

In a computing environment, client devices frequently need to establish connections to data systems in order to transport data. In current implementations, governance requirements for connections are enforced at multiple checkpoints throughout systems without a single interface point. Implementing a single data connection object and creating a data connection catalog may streamline the process of establishing connections between applications and data systems.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1A shows a diagram of a system including a data connection object and a data connection catalog in accordance with one or more embodiments of the invention.

FIG. 1B shows a diagram of a governance system in accordance with one or more embodiments of the invention.

FIG. 1C shows a diagram of a data connection catalogue in accordance with one or more embodiments of the invention.

FIG. 2A shows a flowchart of a method for creating a data connection object in accordance with one or more embodiments of the invention.

FIG. 2B shows a flowchart of a method for establishing a connection in accordance with one or more embodiments of the invention.

FIG. 3 shows a diagram of an example in accordance with one or more embodiments of the invention.

FIG. 4 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regards to any other figure. For brevity, descriptions of these components will not be repeated with regards to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of the figures may be labeled as A to N. As used herein, the aforementioned labeling means that the element may include any number of items and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

In general, embodiments of the invention relate to systems and methods for generating a data connection object in order to establish a connection between an application on a client device and a host in a data system. One or more embodiments improve upon traditional methods of establishing connections, which are currently very complex and do not have a single interface that unifies basic data governance requirements needed to connect to a data system. Current implementations require that the application itself include the functionality to manage governance requirements, which adds complexity to the software of the application.

In one or more embodiments of the invention, a data connection object is created by an application on a client device in order to process a connection request between the client device and a host in a data system. This data connection object includes the capability to obtain information about previously established connections and the data governance system. In one or more embodiments of this invention, a data connection catalog is continuously updated to reflect the status of connections for the client device. New entries in the data connection catalog are generated for each new connection made, creating a database for data connection objects to access in order to be up to date on the most recent governance requirements that have been met by previous requests.

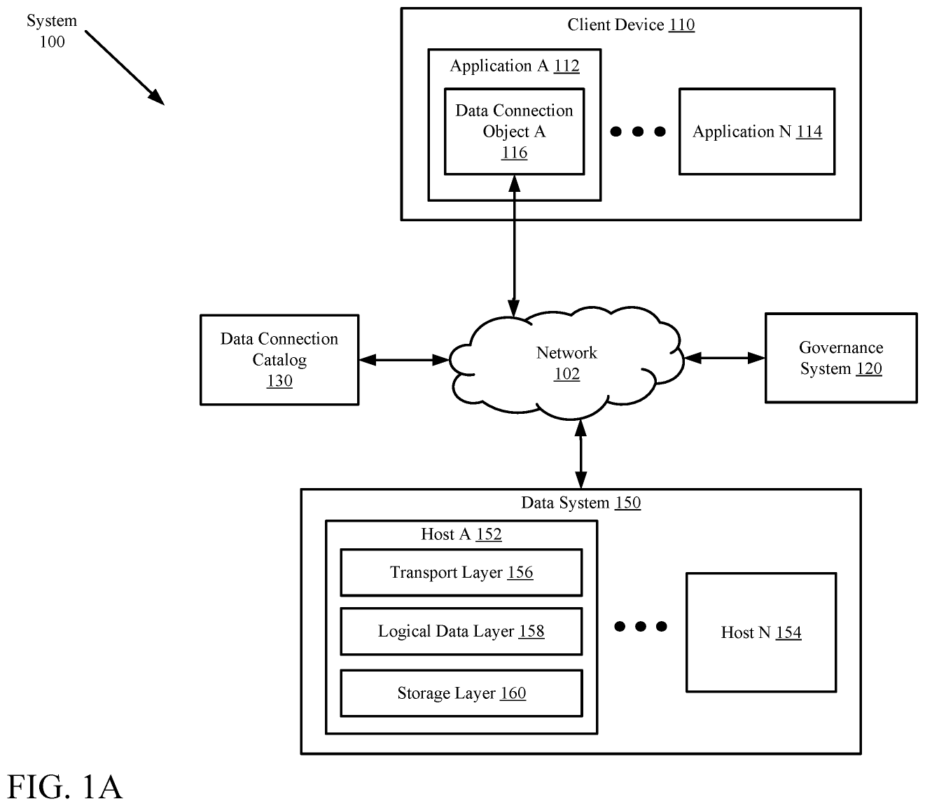

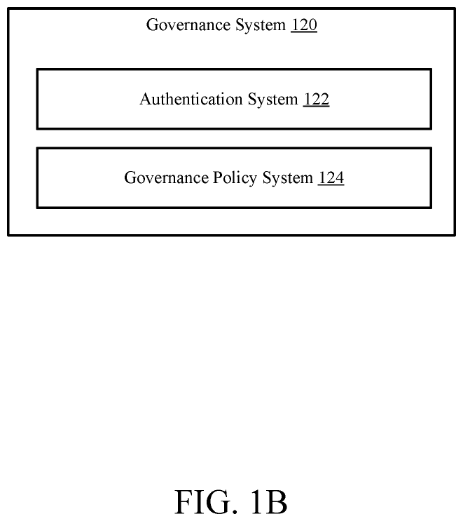

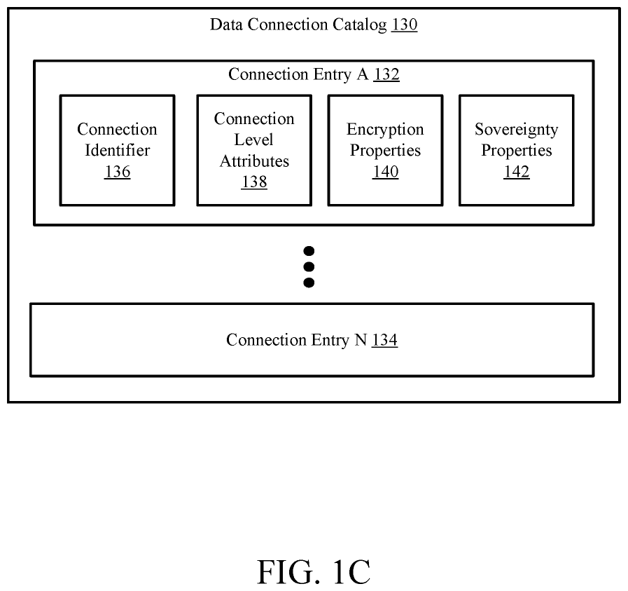

FIG. 1A shows a diagram of a system in accordance with one or more embodiments of the invention. The system may include a network (102), a client device (110), a governance system (120), a data connection catalog (130), and a data system (150). The system may include additional, fewer, and/or other components without departing from the invention. Each of the components in the system may be operatively connected via the network (102). Each of the aforementioned components of the system (100) is discussed below.

In one or more embodiments, the network (102) is the network that performs the functionality of allowing communication between components of the system described throughout this application. A network (e.g., network (102)) may refer to an entire network or any portion thereof (e.g., a logical portion of the devices within a topology of devices). A network may include a data center network, wide area network, local area network, wireless network, cellular phone network, and/or any other suitable network that facilitates the exchange of information from one part of the network to another. A network may be located at a single physical location or be distributed at any number of physical sites. In one or more embodiments, a network may be coupled with or overlap, at least in part, with the Internet.

In one or more embodiments, although shown separately in FIG. 1A, the network (102) may include any number of devices within any components (e.g., 110, 120, 130, 150) of the system, as well as devices external to or between such components of the system. A network device may include any other components without departing from the invention. Examples of a network device include, but are not limited to, a network switch, router, multilayer switch, fiber channel device, an InfiniBand® device, etc. A network device is not limited to the aforementioned specific examples.

The network (102) may include any number of devices within any components of the system, as well as devices external to or between such components of the system. The network (102) provides the operative connectivity between the client device (110), the governance system (120), the data connection catalog (130), and the data system (150). Each of the aforementioned system components connected by the network (102) will be described in detail below.

In one or more embodiments, the client device (110) may refer to a device that is operatively connected to the network (102). The client device (110) may utilize computer implemented services provided by other components of the system such as, for example, the governance system (120), data connection catalog (130), and the data system (150). Services provided by these components may include, but are not limited to, providing information on data governance, providing a catalog of previous connections, and data storage. While the system (100) illustrates one client device (110), the system may include any number of client devices without departing from the invention. The client device may include a plurality of applications (112, 114), discussed at length below.

In one or more embodiments, a client device (110) is implemented as a computing device. A computing device may be, for example, a mobile phone, tablet computer, laptop computer, desktop computer, server, distributed computing system, or cloud resource. The computing device may include one or more processors, memory (e.g., random access memory), and persistent storage (e.g., disk drives, solid state drives, etc.). The computing device may include instructions stored on the persistent storage, that when executed by the processor(s) of the computing device it causes the computing device to perform the functionality of a client device (110) as described throughout this application.

In one or more embodiments of the invention, the client device (110) is implemented as a logical device. The logical device may utilize the computing resources of any number of computing devices and thereby provide the functionality of the client device (110) as described throughout this application.

In one or more embodiments, the applications (112, 114) refer to at least one application that may exist on the client device (110) and may perform a variety of functionalities for the client device. Functionalities of the applications may include a plurality of different tasks, including but not limited to any number of software, data managers, media players, data collection, etc. Each application (112, 114) may include at least one data connection object (116), discussed at length below.

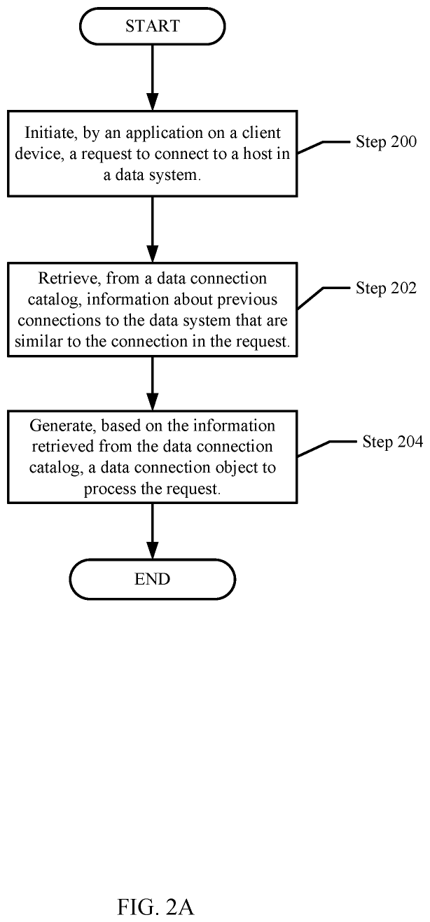

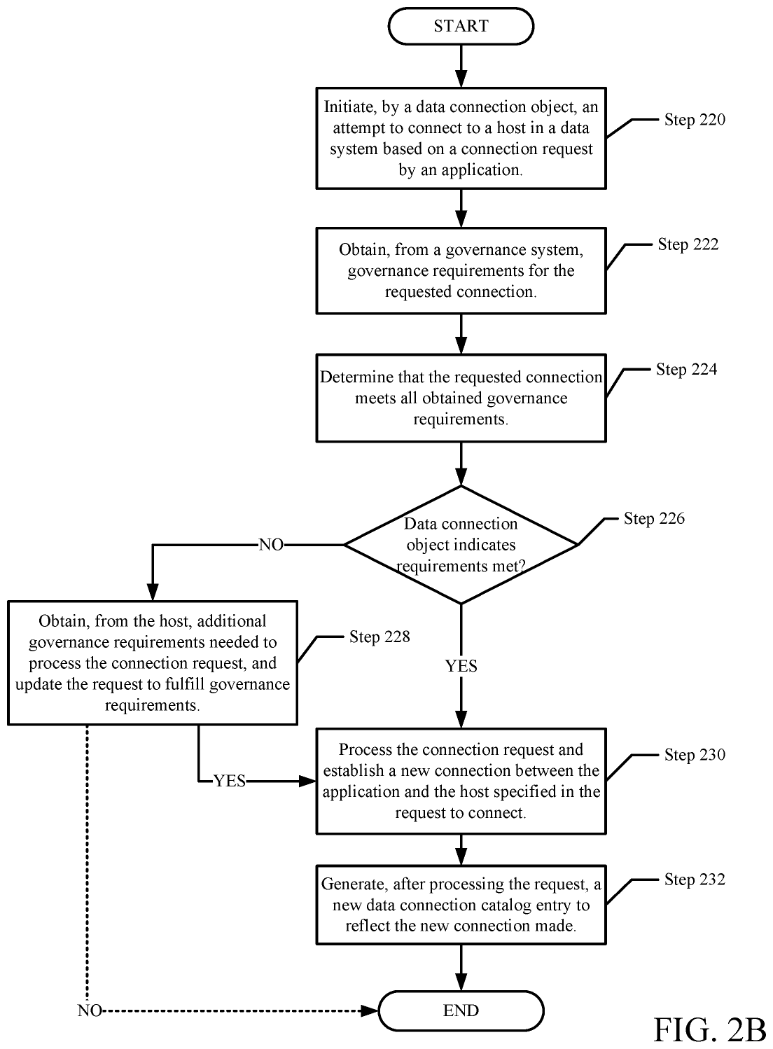

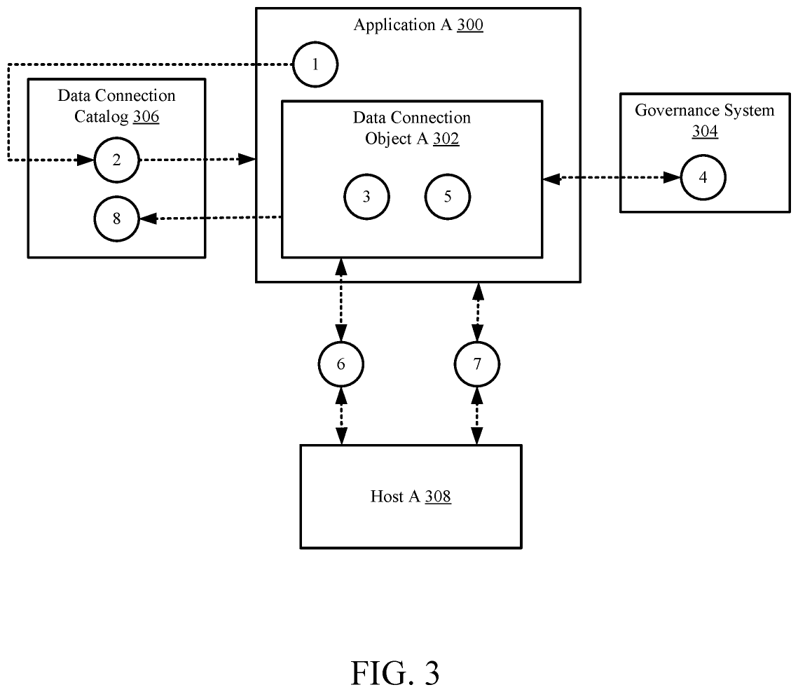

In one or more embodiments, a data connection object (116) may refer to an instance of a connection to a data system (150), implemented as software that can be used by an application (112, 114) on a client device (110). An application (112, 114) may generate a data connection object (116) based on information obtained from the data connection catalog (130) described in detail below. The data connection object (116) may include the functionality to, but is not limited to, process a connection request from an application, connect to the data system, obtain governance properties from different layers of the host, and verify, negotiate, or enforce the required governance properties for connections. Additional information on the generation and functionality of the data connection object may be found, for example, in FIGS. 2A, 2B, and 3.

In one or more embodiments, the governance system (120) refers to a system that provides governance requirements to a client device (110). The governance requirements may apply to, but are not limited to, a plurality of client devices on a client system (not shown). The governance system (120) may include an authentication system (122, FIG. 1B) and a governance policy system (124, FIG. 1B). Additional information on the governance system (120) and its components can be found, for example, in FIGS. 1B and 2B.

In one or more embodiments, the data connection catalog (130) refers to a catalog used by an application (112, 114) to generate a data connection object (116). The data connection catalog (130) may include a plurality of connection entries (132, 134, FIG. 1C) that represent previous connections made between the client device (110) and the data system (150). Additional information on the data connection catalog (130) can be found, for example, in FIGS. 1C and 2A.

In one or more embodiments, the data system (150) may include a plurality of hosts (152, 154). The data system may provide computer-implemented services to users. The data system (150) may operate in a computing environment, accessible by the client device (110) or any other entity via the network (102). In one or more embodiments, the computer-implemented services provided by the hosts (152, 154) on the data system (150) may include data storage, data processing, data collection, and application execution. Other computer-implemented services may be offered by the data system (150) without departing from the invention. The data system (150) may include additional, fewer, and/or other components without departing from the invention. Each of the aforementioned components of the data system (150) is discussed below.

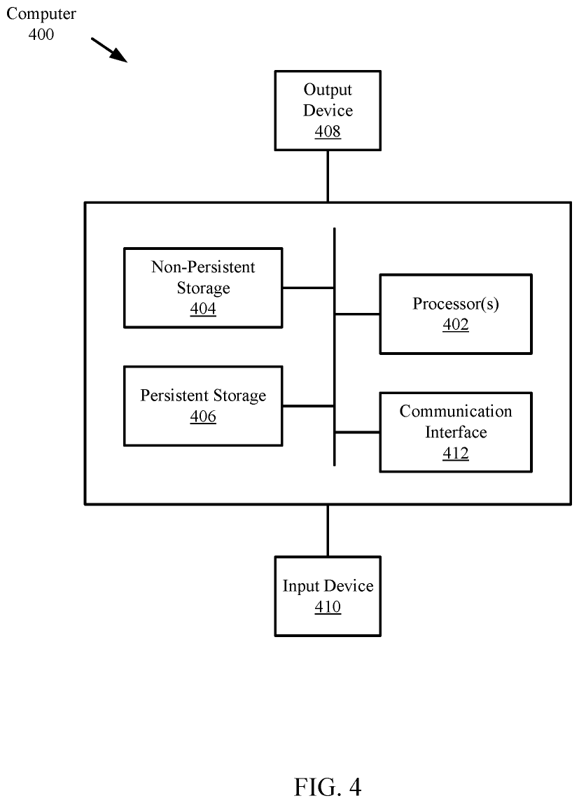

In one or more embodiments, each of the hosts (152, 154) on the data system (150) may be implemented as a computing device (see e.g., FIG. 4). The computing device may be, for example, a mobile phone, tablet computer, laptop computer, desktop computer, server, distributed computing system, or cloud resource. The computing device may include one or more processors, memory (e.g., random access memory), and persistent storage (e.g., disk drives, solid state drives, etc.). The computing device may include instructions stored on the persistent storage, that when executed by the processor(s) of the computing device, it causes the computing device to perform the functionality of the hosts (152, 154) as described throughout this application. Each host may include a transport layer (156), a logical data layer (158), and a storage layer (160). A host (150) may include additional, fewer, and/or other components without departing from the invention. Each of the aforementioned components of the host (152, 154) is discussed below.

In one or more embodiments, the transport layer (156) refers to the layer in the host (152, 154) that includes properties of the host that relate to the encryption of data in motion. Properties required by this layer that relate to data in motion may include, but are not limited to, governance requirements that relate to the transfer of data. In the context of this invention, data may be transferred between an application (112, 114) on a client device and a host (152, 154). Data must be protected during transport, and encryption ensures the transport layer (156) is able to protect the data while it is being transported over the network (102).

In one or more embodiments, the logical data layer (158) refers to the layer in the host (152, 154) that includes properties of the host that related to the sovereignty of data. Data sovereignty refers to the concept that data is subject to the laws and governance requirements of the location where the data was created. Requirements that may be included in this logical data layer (158) may include, but are not limited to, regional data security certifications, data security requirements at the physical location of the client, privacy laws based on geographical location, etc. An example of an implementation of data sovereignty that would include governance requirements would be the General Data Protection Regulation (GDPR), which includes a multitude of general data protection regulation guidelines.

In one or more embodiments, the storage layer (160) refers to the layer in the host (152, 154) that includes properties of the host that relate to the encryption of data at rest. Properties required this layer include, but are not limited to, encryption properties for data that is being stored securely on a host (152, 154). Data must be protected at rest, and encryption ensures the storage layer (160) is able to protect the data while it is being stored in a host.

Turning now to FIG. 1B, FIG. 1B shows a diagram of the governance system (120) in accordance with one or more embodiments of the invention. The governance system (120) of FIG. 1B may be an embodiment of a governance system (120, FIG. 1A) discussed above. The governance system (120) may include an authentication system (122) and a governance policy system (124). The governance system (120) may include additional, fewer, and/or different components without departing from the invention. Each of the aforementioned components of the governance system (120) is discussed below.

In one or more embodiments, the authentication system (122) refers to a system that stores and manages information about all devices and objects on a network. It acts as a directory-based identity-related service for administrators to use to determine which users and devices are allowed access to parts of the system. In the context of this invention, the data connection object (116, FIG. 1A) utilizes this component of the governance system (120) to determine if the application (112, 114, FIG. 1A) on a client device (110, FIG. 1A) has access to a host (152, 154, FIG. 1A) that it may request to connect to. More information on the functionality of the authentication system can be found, for example, in FIGS. 2B and 3.

In one or more embodiments, the governance policy system (124) refers to a system that manages and controls access to data in a data system. It ensures compliance with and provides governance requirements by monitoring and enforcing compliance rules. The governance policy system (124) may also specify encryption requirements for connections, whether for data at rest or for data in motion. In the context of this invention, the governance policy system (124) provides governance requirements for which applications (112, 114, FIG. 1A) on the client device (110, FIG. 1A) are allowed to connect with and access data on specific hosts (152, 154, FIG. 1A). More information on the functionality of the governance policy system can be found, for example, in FIGS. 2B and 3.

Turning now to FIG. 1C, FIG. 1C shows a diagram of a data connection catalog (130) in accordance with one or more embodiments of the invention. The data connection catalog of FIG. 1C may be an embodiment of the data connection catalog (130, FIG. 1A) discussed above. The data connection catalog (130) may include a plurality of connection entries (132, 134). Each connection entry (132, 134) corresponds to one connection made between an application (112, 114) on a client device (110) and a host (152, 154) in a data system (150). Each connection entry includes a connection identifier (136), connection level attributes (138), encryption properties (140), and sovereignty properties (142). Each of the aforementioned components of the connection entries (132, 134) is described below. The data connection catalog (130) may include additional, fewer, and/or different components without departing from the invention. Each of the aforementioned components of the data connection catalog (130) is discussed below.

In one or more embodiments, the connection identifier (136) refers to an alpha, numeric, or alpha-numeric string that is used to identify the connection. A connection identifier (136) may be generated (or otherwise derived) from information associated with the connection, including type of connection, time of connection, properties of the connection, etc. For example, the various attributes of the connection may be obtained and then a hash function may be applied to these attributes in order to generate a connection identifier. The connection identifier (136) may be used by a data connection object (116, FIG. 1A) to obtain information about the connection from a data connection catalog (130). Additional information on the functionality of connection identifiers can be found, for example, in FIGS. 2A and 3.

In one or more embodiments, the connection level attributes (138) may refer to a multitude of attributes that dictate the level of connectivity that a client device (110) has to one or more of the plurality of hosts (152, 154) in the data system (150). Connection level attributes may refer to the type of connection, which may be, but is not limited to, direct, indirect, via a wide area network, via a gateway, etc. Additional information on the functionality of connection level attributes (138) can be found, for example, in FIGS. 2A and 3. The encryption properties (140) refer to the properties of the connection as dictated in the transport layer (156, FIG. 1A) and storage layer (160) required by the host (152, 154, FIG. A) that the client device (110, FIG. A) connected to. The sovereignty properties (142) refer to the properties of the connection as dictated in the logical data layer (158, FIG. 1A) discussed above.

Required properties in both of these components, established in previous connections, allow the data connection object (114, 116) to collect information about previous similar connections. A data connection object may be able to query or search the data connection catalog for previous connections with similar connection level attributes (138), encryption properties (140), and sovereignty properties (142) in order to utilize relevant connection entries (132, 134) for a specific connection request.

Turning now to FIG. 2A, FIG. 2A shows a flowchart of a method for generating a data connection object in accordance with one or more embodiments of the invention. The method may be performed by, for example, an application on a client device (112, 114, FIG. 1A). Other components of the system illustrated in FIGS. 1A-1C may perform all, or a portion, of the method of FIG. 2A without departing from the invention.

While FIG. 2A is illustrated as a series of steps, any of the steps may be omitted, performed in a different order, include additional steps, and/or perform any or all of the steps in a parallel and/or partially overlapping manner without departing from the invention.

In Step 200, a request to connect to a host in a data system is initiated by an application on a client device. This connection request may be initiated, for example, to obtain access to data storage services provided by the data system.

In Step 202, information about previous connections is retrieved from a data connection catalog. The data connection catalog has a plurality of connection entries, and entries that include information about similar or related connections that have occurred previously may be specified. Specific connection entries may be retrieved using their connection identifier, or selected based on desired governance properties. Specific properties may be included in the catalog as connection level attributes, encryption properties, or sovereignty properties.

In Step 204, a data connection object is generated based on the information retrieved from the data connection catalog. The data connection object is implemented as a software library that will be usable by the application on the client node in order to assist in the connection to a host in the data system, discussed at length in FIG. 2B.

Turning now to FIG. 2B, FIG. 2B shows a flowchart of a method for establishing a connection between an application and a host in accordance with one or more embodiments of the invention. The method may be performed by, for example, the data connection object (116, FIG. 1A). Other components of the system illustrated in FIGS. 1A-1C may perform all, or a portion, of the method of FIG. 2B without departing from the invention.

While FIG. 2B is illustrated as a series of steps, any of the steps may be omitted, performed in a different order, include additional steps, and/or perform any or all of the steps in a parallel and/or partially overlapping manner without departing from the invention.

In Step 220, an attempt to connect to a host in a data system is initiated by a data connection object. The attempt initiated by the data connection object is based on a connection request by an application on a client device. The connection request by an application may include a specific host on the data system that the client device is requesting to connect to.

In Step 222, governance requirements for the requested connection are obtained by the data connection object from a governance system. Governance requirements for the connection specified in the request to connect obtained in this step may come from either the authentication system or the governance policy system components of the governance system. As discussed above, the governance requirements obtained from the governance system (such as a governance policy system (124, FIG. 1B)) may include encryption requirements. The encryption requirements may include requirements for data at rest encryption and/or data in motion encryption. Other encryption requirements may be included in the governance requirements without departing from the invention.

In Step 224, the data connection object determines if the requested connection meets all obtained governance requirements. These requirements may come from the specified governance properties in the data connection catalog used to generate the data connection object, or from the governance requirements obtained from the governance system in Step 222.

In Step 226, a determination is made about whether or not the data connection object indicates that the properties of the requested connection meet all governance requirements. If the data connection object indicates that requirements have not been met, the method proceeds to Step 228; if the data connection object indicates that requirements have been met, the method proceeds to Step 230.

In Step 228, the data connection object obtains additional governance requirements needed to process the connection request from the host specified in the request. These additional governance requirements may be obtained from the transport layer, the logical data layer, and/or the storage layer of the host. From these layers, the data connection object may obtain requirements that were not previously known from the data connection catalog or governance system, as they may have just been added or updated on the individual host. The governance requirements obtained from the host may include specific properties related to encryption and sovereignty of the data involved in the transfer that may take place after a connection is made. Once any additional requirements are obtained, the data connection object may update the attempt to connect to the host. This updating may include verifying, negotiating, or enforcing the governance requirements in order to update the connection attempt so that it is accepted to connect to the host. If the additional requirements are met by the connection specified in the connection request, the method proceeds to Step 230 for processing. If the governance requirements cannot be satisfied in Step 228, the connection to the host in the data system is denied, and the method ends following Step 228.

In Step 230, the data connection object processes the connection attempt and establishes a new connection between the application and the host specified in the request to connect. This connection is made over the network, and allows for the transfer of data between the client device and the data system.

In Step 232, a new connection entry in the data connection catalog is generated to reflect the newly established connection after processing the request. The new connection entry includes a connection identifier, connection level attributes for the connection, encryption properties, and sovereignty properties. This connection entry may be used to provide information for data connection objects in future connection attempts.

### EXAMPLE

The following section describes an example. The example, illustrated in FIG. 3, is not intended to limit the invention. Turning to the example, consider a scenario in which a system includes a client node that requests a restoration of a specific version of a data asset.

Turning to FIG. 3, FIG. 3 shows a diagram of an example system. For the sake of brevity, not all components of the example system are illustrated in FIG. 3. The example system includes at least an application A (300) containing a data connection object A (302), a governance system (304), a data connection catalog (306), and a host A (308). Other components in the system depicted in FIGS. 1A-1C may perform all, or a portion of the steps shown in FIG. 3 without departing from the scope of the invention.

In the following example, a sequence of operations illustrated in FIG. 3 as the circled numbers are described below using brackets.

In this methodology, an application A (300) initiates a request to connect to a host A (308) [1]. The first step of processing this request is to access the data connection catalog (306) to identify previous connections that may share similar attributes. Information about similar previous connections is obtained [2] and used to generate a data connection object A (302) in order to process the data connection request [3]. Data connection object A (302) then accesses a governance system (304) over the network to obtain current governance requirements for the system, which may be from an authentication system or a governance policy system [4]. The data connection object A (302) then determines that the initial connection request meets all requirements outlined in the governance system (304) and is allowed to attempt a connection to host A (308) [5]. In this example, there may be outlying attributes of the connection request that data connection object A (302) is trying to process that it does not yet have information on. In order to collect complete governance requirement information from host A (308), data connection object A (302) may interact with different layers of host A [6]. In this interaction, data connection object A (302) retrieves any information provided by host A (308) for establishing the connection and meeting requirements of the data system (not shown) of host A (308), and update the connection request in order to best meet the additional governance requirements. Once all governance requirements are met, data connection object A (302) fully processes the request and establishes a connection between the application A (300) and host A (308) [7]. To ensure that the data connection catalog (306) is up to date and available for future connection attempts, a new connection entry is generated by the data connection object and stored to reflect the new connection established between application A (300) and host A (308) [8].

### END OF EXAMPLE

As discussed above, embodiments of the invention may be implemented using computing devices. Turning now to FIG. 4, FIG. 4 shows a diagram of a computing device in accordance with one or more embodiments of the invention. The computer (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth® interface, infrared interface, network interface, optical interface, etc.), input devices (410), output devices (408), and numerous other elements (not shown) and functionalities. Each of these components is described below.

In one embodiment of the invention, the computer processor(s) (402) may be an integrated circuit for processing instructions. For example, the computer processor(s) (402) may be one or more cores or micro-cores of a processor. The computer (400) may also include one or more input devices (410), such as a touchscreen, keyboard, mouse, microphone, touchpad, electronic pen, or any other type of input device. Further, the communication interface (412) may include an integrated circuit for connecting the computer (400) to a network (not shown) (e.g., a local area network (LAN), a wide area network (WAN) such as the Internet, mobile network, or any other type of network) and/or to another device, such as another computing device.

In one embodiment of the invention, the computer (400) may include one or more output devices (408), such as a screen (e.g., a liquid crystal display (LCD), plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many diverse types of computing devices exist, and the aforementioned input and output device(s) may take other forms.

One or more embodiments of the invention may be implemented using instructions executed by one or more processors of the system including a client device, a governance system, a data connection catalog, and a data system. Further, such instructions may correspond to computer readable instructions that are stored on one or more non-transitory computer readable mediums.

One or more embodiments of the invention may improve the operation of one or more computing devices in a customer system. Specifically, embodiments of the invention relate to a system and method for establishing a connection between an application on a client device and a host in a data system. Current implementations of methods lack a single interface for information on the governance requirements of a connection in addition to any additional requirements for establishing connections for data across various domains (e.g., political domains such as countries) of sovereignty. These embodiments improve upon the previous method by creating a unified entity in the form of a data connection object that includes all information on the governance requirements streamline the connection process between an application and a data system.

The problems discussed above should be understood as being examples of problems solved by embodiments of the invention disclosed herein and the invention should not be limited to solving the same/similar problems. The disclosed invention is broadly applicable to address a range of problems beyond those discussed herein.

While the invention has been described with respect to a limited number of embodiments, those skilled in the art, having benefit of this disclosure, will appreciate that other embodiments can be devised which do not depart from the scope of the technology as disclosed herein. Accordingly, the scope of the invention should be limited only by the attached claims.

What is claimed is:

1. A method for establishing a connection, the method comprising:
initiating, by a data connection object, a first attempt to establish a first connection between an application and a first host in a data system;
obtaining, from a governance system, governance requirements for the first connection;
making a first determination that the first connection meets the governance requirements;
establishing, in response to the first determination, the first connection between the application and the first host; and
generating, after the establishing, a first new entry on a data connection catalog associated with the first connection.

2. The method of claim 1, wherein the data connection catalog comprises a plurality of entries for a plurality of connections, wherein each entry of the plurality of entries comprises information for one connection of the plurality of connections, wherein the information comprises at least one of a list consisting of: a connection identifier of the one connection, a connection level attribute, an encryption property, and a sovereignty property.

3. The method of claim 1, wherein the data connection object is generated by the application based on information included in previous entries on the data connection catalog.

4. The method of claim 1, wherein the governance requirements stored on the governance system comprise a plurality of requirements associated with at least one of a list consisting of: an authentication system and a governance policy system.

5. The method of claim 1, further comprising:
initiating, a second attempt to establish a second connection between the application and a second host;
making a second determination that the second connection does not meet the governance requirements;
obtaining, from the second host, additional requirements associated with the second connection and based on the second determination;
updating, based on the second determination and the additional requirements, the second attempt to establish the second connection;
establishing, after the updating, the second connection between the application and the second host; and
generating, after the establishing, a second new entry on the data connection catalog associated with the second connection and any changes made to the second connection in the updating.

6. The method of claim 5, wherein the additional requirements comprise requirements for transporting data between the application and the second host, wherein the additional requirements are obtained from at least one of a list consisting of: a transport layer, a logical data layer, and a storage layer of the second host.

7. The method of claim 5, wherein the additional requirements specify encryption properties for transporting and storing data between the application and the second host.

8. The method of claim 5, wherein the second new entry on the data connection catalog specifies updates made to the second connection during the updating.

9. A system, comprising:
a data connection catalog;
a governance system;
a data system, comprising a plurality of hosts;
a client device, comprising circuitry;
an data connection object executing on the circuitry, programmed to:
initiate a first attempt to establish a first connection between an application of the client device and a first host of the plurality of hosts;
obtain, from the governance system, governance requirements for the first connection;
make a first determination that the first connection meets the governance requirements;
establish, in response to the first determination, the first connection between the application and the first host; and
generate, after the establishing, a first new entry on the data connection catalog associated with the first connection.

10. The system of claim 9, wherein the data connection catalog comprises a plurality of entries for a plurality of connections, wherein each entry of the plurality of entries comprises information for one connection of the plurality of connections, wherein the information comprises at least one of a list of: a connection identifier of the one connection, a connection level attribute, an encryption property, and a sovereignty property.

11. The system of claim 9, wherein the data connection object is generated by the application based on information included in previous entries on the data connection catalog.

12. The system of claim 9, wherein the governance requirements stored on the governance system comprise a plurality of requirements from at least one of a list consisting of: an authentication system and a governance policy system.

13. The system of claim 9, wherein the data connection object is further programmed to:
initiate a second attempt to establish a second connection between the application and a second host;
make a second determination that the second connection does not meet the governance requirements;
obtain, from the second host, additional requirements associated with the second connection and based on the second determination;
update, based on the second determination and the additional requirements, the second attempt to establish the second connection;
establish, after the updating, the second connection between the application and the second host; and
generate, after the establishing, a second new entry on the data connection catalog associated with the second connection and any changes made to the second connection in the updating.

14. The system of claim 13, wherein the additional requirements comprise requirements for transporting data between the application and the second host, wherein the additional requirements are obtained from at least one of a list consisting of: a transport layer, a logical data layer, and a storage layer of the second host.

15. The system of claim 13, wherein the additional requirements specify encryption properties for transporting and storing data between the application and the second host.

16. The system of claim 13, wherein the second new entry on the data connection catalog specifies updates made to the second connection during the updating.

17. A non-transitory computer readable medium comprising computer readable program code, which when executed by a computer processor enables the computer processor to perform a method for establishing a connection, the method comprising:
initiating, by a data connection object, a first attempt to establish a first connection between an application and a first host in a data system;
obtaining, from a governance system, governance requirements for the first connection;
making a first determination that the first connection meets the governance requirements;
establishing, in response to the first determination, the first connection between the application and the first host; and
generating, after the establishing, a first new entry on a data connection catalog associated with the first connection.

18. The non-transitory computer readable medium of claim 17, wherein the method further comprises:
initiating, a second attempt to establish a second connection between the application and a second host;
making a second determination that the second connection does not meet the governance requirements;
obtaining, from the second host, additional requirements associated with the second connection and based on the second determination;
updating, based on the second determination and the additional requirements, the second attempt to establish the second connection;
establishing, after the updating, the second connection between the application and the second host; and
generating, after the establishing, a second new entry on the data connection catalog associated with the second connection and any changes made to the second connection in the updating.

19. The computer readable medium of claim 18, wherein the additional requirements comprise requirements for transporting data between the application and the second host, wherein the additional requirements are obtained from at least one of a list consisting of: a transport layer, a logical data layer, and a storage layer of the second host, wherein the additional requirements specify encryption properties for transporting and storing data between the application and the second host.

20. The computer readable medium of claim 18, wherein the second new entry on the data connection catalog specifies updates made to the second connection during the updating.
